(19) United States
(12) Patent Application Publication
(10) Pub. No.: US 2002/0118481 A1
(43) Pub. Date: Aug. 29, 2002

(54) Digital media cartridge status indicator

(76) Inventor: Phillip T. Ingram, San Jose, CA (US)

Correspondence Address: Tom Van Zandt, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/797,075

(22) Filed: Feb. 28, 2001

(51) Int. Cl. G11B 15/18; G11B 17/00

(52) U.S. Cl. 360/69; 360/71; 360/132

(57) ABSTRACT

A method for automatically providing tape status discernible through visual inspection is disclosed. The status a recording medium tape device is determined. The tape, which is housed in a cartridge, has leader tape having segments with distinctive markings. Each of these markings is used to indicate a particular tape status. These markings may simply be a variety of colors with each color indicating a particular tape status. At the time the tape is ejected it is automatically rewound so that a marked segment of leader tape having a marking indicating the tape status, aligns with a reference pointer located on the cartridge such that the marking is visible through the cartridge. An intended advantage of one embodiment of the present invention is to provide an automatic display of the cartridge status. Another intended advantage of one embodiment of the present invention is to allow a user to determine the status of the recording medium cartridge by visual inspection.

### FIELD OF THE INVENTION

This invention relates generally to recording medium cartridges that contain memory devices for storing information regarding the recorded contents, and more specifically to the characterization of the recording medium.

### BACKGROUND

Recent advances in recording medium technology have led to a tremendous increase in storage capacities and data transfer rates of, for example, magnetic tape cassettes. The resultant need to improve the tape drive's ability to access stored data has led to the incorporation within the tape cassette of a memory device to promote higher efficiency in the management and retrieval of the stored data. Such memory-in-cassette (MIC) devices, typically employ an electrically erasable programmable read only memory (EEPROM) that allows direct and immediate connection to the tape drive's memory. This allows the MIC to be programmed to set up the preliminary format of the tape (e.g., partitioning the tape). This information need not be read from the tape, but can be obtained electronically from memory.

MIC technology provides many advantages over previous tape-cassette technology. These advantages include data accessing time and ensuring media and data integrity, among others. For example, on a traditional tape drive, the system log that indicates where a particular data file can be found on the tape, is written at the header of each cartridge. This means that to locate a particular data file, the tape is rewound to the beginning so that the drive can read the system log and transfer it into the drive's memory. Then the tape must be advanced or rewound slowly enough for the drive to read the data file indices along the tape. In a MIC device, the system log is written to memory. The MIC substantially reduces access time by estimating the distance to the particular data file and moving the tape at high speed until the approximate location is reached.

The ability to ensure media and data integrity is enhanced by the ability of the MIC device to maintain relevant statistics. These statistics include the number of times the cassette has been loaded, the number of times each area of the tape has been accessed, and the total error correction code (ECC) error counts, among other information.

This information can be obtained by accessing the memory of the MIC device. The status of the tape can then be indicated through any of the numerous prior art status-indication schemes. Such status notation is time-consuming and prone to error.

### BRIEF DESCRIPTION OF THE DRAWINGS

The present invention is illustrated by way of example and not limitation in the figures of the accompanying drawings in which like references indicate similar elements and in which:

FIGS. 1A, 1B, and 1C depict a recording medium cartridge having a status indicator in accordance with the present invention; and

FIG. 2 is a process flow diagram in accordance with one embodiment of the present invention.

### SUMMARY OF THE INVENTION

The status of a tape of a recording medium tape device is determined. The tape, which is housed in a cartridge, has leader tape having segments with distinctive markings. Each of these markings is used to indicate a particular tape status. These markings may simply be a variety of colors with each color indicating a particular tape status. At the time the tape is ejected it is automatically rewound so that a marked segment of leader tape having a marking indicating the tape status, aligns with a reference pointer located on the cartridge such that the marking is visible through the cartridge.

### DETAILED DESCRIPTION

A method and apparatus for providing a recording medium cartridge with an automatic status indicator are described.

As described in greater detail below, an embodiment of the invention is a MIC device having a status indicator through which a user may determine the status of the cassette by visual inspection. Segments of leader tape are color-coded to reflect various tape conditions of interest to the user for example, tape conditions may include new, initialized, excessive ECC error counts, or secured, among others. When the tape is rewound the segment of colored leader tape associated with the condition of the tape is automatically positioned so as to be visible through an inspection area located on the tape cartridge. In an alternative embodiment, colored segments of leader tape may be replaced with segments of leader tape having any distinctive marking to indicate tape status.

An intended advantage of one embodiment of the present invention is to provide an automatic display of the cartridge status. Another intended advantage of one embodiment of the present invention is to allow a user to determine the status of the recording medium cartridge by visual inspection.

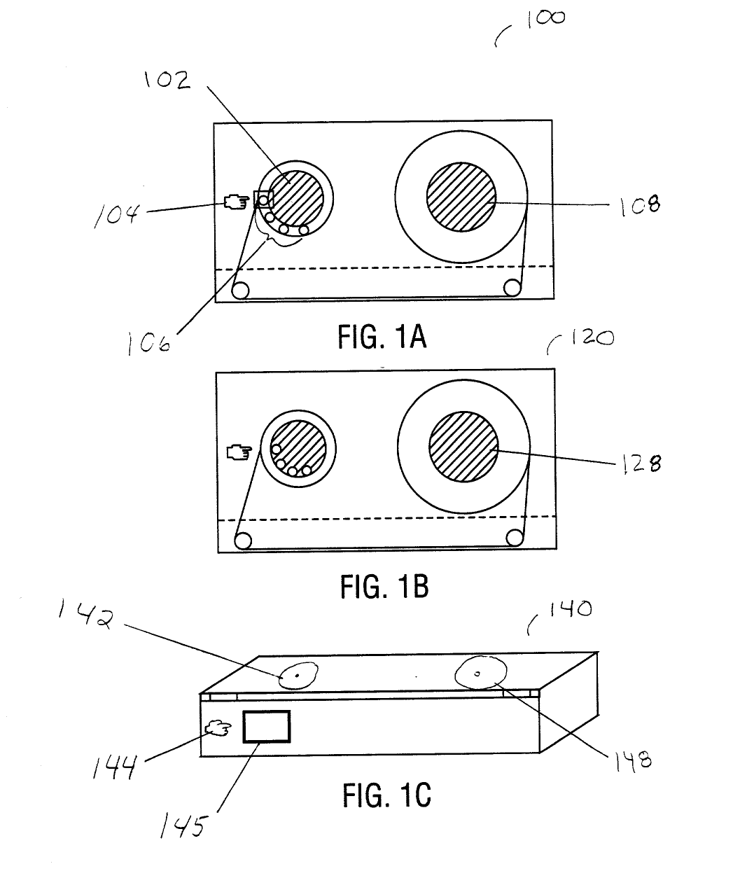

FIG. 1A depicts a MIC cartridge in accordance with one embodiment of the present invention. The cartridge 100 shown in FIG. 1A has a pickup reel 102 onto which leader tape remains wound when the tape is rewound onto reel 108. Cartridge 100 also includes a reference pointer 104 that indicates an area of the leader tape spool on pickup reel 102.

In one embodiment of the present invention the leader tape contains a number of colored segments. Each color is associated with a particular status, or characteristic of the tape. The number of colors depends on the total number of tape characteristics to be discerned. For example, the leader tape may include green segments to indicate an initialized tape, yellow segments to indicate that ECC errors are present, orange segments to indicate an excessive level of ECC errors, and red segments to indicate a secure tape. The leader tape contains multiple (e.g., five) segments of each color that are positioned so that as the leader tape is rewound on the pickup reel, the segments of a given color will align on the leader tape spool. This is accomplished through stacking, i.e., aligning, the color through five, or more, wraps of leader tape on the pickup spool. The color segments of each color used to indicate a status of the tape are positioned in a like manner. Each of the colored markings 106 is of a different color created when segments of leader tape, of that color, align as the tape is wound around the pickup reel. This positioning results in visible colored markings 106 on the leader tape spool when viewed through an inspection window on the top of the cartridge 100.

An alternative embodiment is implemented without an inspection window. In such an embodiment some or all of the colored markings 106 are visible, and the colored marking that indicates the tape status is aligned to reference pointer 104.

The MIC is programmed with an algorithm that aligns the appropriate colored marking with the reference pointer 104, i.e., the colored marking associated with the tape status is aligned to the reference pointer 104 and is visible to the user through an inspection window on the cartridge. For example, a clear leader tape indicator may be used for a new, unused, tape; upon initialization the drive will be coded to rewind, upon tape eject, so that the color indicating an initialized tape (e.g., green) is aligned with the reference pointer. As the tape is used and media anomalies are discovered through ECC, the device will update the leader tape alignment algorithm so that, upon eject, the appropriate color marking (i.e., the color indicating the current error status of the tape) is aligned with the reference pointer.

The tape status indication scheme of the present invention can also be used to indicate the end of tape life. The tape may be date stamped so that the data can only be used for a predetermined time. At the end of this time, the leader tape alignment algorithm will re-position the leader tape so that the color marking indicating end of tape life is aligned with the reference pointer.

Tape security is another area in which it is desirable that the MIC automatically provide tape status and that the status is discernible through visual inspection. A secure tape is one that provides only limited or time-sensitive access. For example, a tape may be time-stamped upon formatting so that the tape is rendered unreadable after a specified time. Such a tape may be rendered unreadable via MIC programming that causes the data to be erased after a specified time has been exceeded. The tape may be formatted so that after the specified time has expired the data can only be accessed with a key code. In such cases a visually discernible status indicator informs the user, prior to use, that the tape is secure.

FIG. 1B depicts an alternative embodiment of the present invention. The cartridge 120 shown in FIG. 1B has a pickup reel 122 and a reference pointer 124. In the embodiment of FIG. 1B, the lead tape does not contain colored segments as described above in reference to FIG. 1A. Instead the colored markings 126, indicative of tape status, are on the pickup reel 122. An algorithm programmed into the MIC causes the pickup reel 122 to be positioned so that the appropriate colored marking is aligned with the reference pointer 104 as described above. As described above, the colored marking, indicative of the tape status, may be visible through an inspection window.

FIG. 1C depicts a side view of a MIC cartridge in accordance with another alternative embodiment of the present invention. The cartridge 140 shown in FIG. 1C has a pickup reel 142, a reference pointer 144, and an inspection window 145. In this embodiment the leader tape contains one segment of each color used to indicate status. Since the leader tape is viewed from the front side, the MIC need only position the appropriate colored segment in front of the inspection window to provide the user with a visible status indicator. There is no need to stack a particular color through multiple wraps of leader tape on the pickup spool in order to create a visible indicator. The length of the colored segment of leader tape will be determined by the ability of the tape drive to calibrate tape position.

The leader tape alignment algorithm, described herein, can be implemented by hardware contained within a MIC device. For example, a MIC device can execute code or instructions stored in a machine-readable medium, e.g., the memory of the MIC device, to decide where to position the leader tape.

The machine-readable medium may include a mechanism that provides (i.e., stores and/or transmits) information in a form readable by a machine such as a tape drive. A machine-readable memory may include, for example, a read only memory (ROM). The code or instructions can be represented by digital signals, or by like signals.

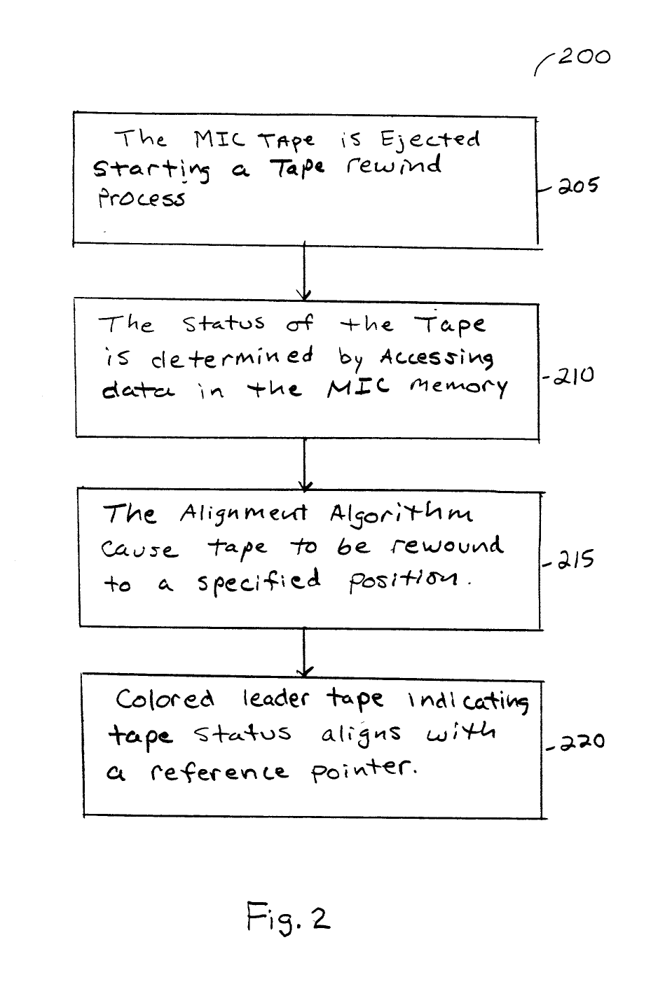

FIG. 2 is a process flow diagram according to one embodiment of the present invention. The process 200 shown in FIG. 2 begins at operation 205 in which a typical MIC tape is ejected causing the tape rewind process to commence. Typically, when a MIC tape is ejected it is automatically rewound to the beginning of tape. In accordance with the present invention, the tape will be rewound to a specified location as described below.

At operation 210 the status of the tape is determined by accessing the information stored in the MIC memory. For example, in a MIC device the drive periodically updates the ECC report and stores this data to memory. This data can be accessed to determine if, for example, the tape has an excessive ECC error rate.

The leader tape alignment algorithm is invoked at operation 215. This algorithm assigns various rewind positions to each particular tape status. The algorithm causes the MIC tape to be rewound to the assigned position corresponding to the current tape status as determined at operation 210.

At operation 220, due to the MIC tape being rewound to the position determined by the algorithm of operation 215, a segment or segments of leader tape having a status-indicating color align with a reference pointer providing visual determination of the tape status.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
determining the status of a tape used in a recording medium tape device, the tape housed in a cartridge, the tape having leader tape comprising marked segments of a plurality of distinctive markings such that each marking indicates a corresponding tape status; and
automatically moving the recording medium tape such that a marked segment of the leader tape having a marking indicative of the tape status is visible through the cartridge.

2. The method of claim 1 wherein the marked segment of leader tape aligns with a reference pointer located on the cartridge.

3. The method of claim 1 wherein moving is selected from the group consisting of winding and rewinding.

4. The method of claim 1 wherein the distinctive markings comprise colors.

5. The method of claim 4 wherein the recording medium tape device is a memory-in-cassette device.

6. The method of claim 4 wherein the colored segment of leader tape is visible through an inspection window.

7. The method of claim 6 wherein the colored segment of leader tape is formed by multiple segments of colored leader tape of the same color positioned to stack upon rewinding.

8. The method of claim 5 wherein the tape status is determined from a group of tape statuses consisting of new, initialized, end of life, error rate warning, error rate exceeded, and secure.

9. An apparatus comprising:
means for determining the status of a tape of a recording medium tape device, the tape housed in a cartridge, the tape having leader tape comprising marked segments of a plurality of distinctive markings such that each marking indicates a corresponding tape status; and
means for automatically moving the recording medium tape such that a marked segment of the leader tape having a marking indicative of the tape status is visible through the cartridge.

10. The apparatus of claim 9 wherein the marked segment of leader tape aligns with a reference pointer located on the cartridge.

11. The apparatus of claim 9 wherein moving is selected from the group consisting of winding and rewinding.

12. The apparatus of claim 9 wherein the distinctive markings comprise colors.

13. The apparatus of claim 12 wherein the recording medium tape device is a memory-in-cassette device.

14. The apparatus of claim 10 wherein the colored segment of leader tape is visible through an inspection window.

15. The apparatus of claim 12 wherein the colored segment of leader tape is formed by multiple segments of colored leader tape of the same color positioned to stack upon rewinding.

16. The apparatus of claim 11 wherein the tape status is determined from a group of tape statuses consisting of new, initialized, end of life, error rate warning, error rate exceeded, and secure.

17. A machine-readable medium that provides executable instructions, which when executed by a processor, cause the processor to perform a method, the method comprising:
determining the status of a tape of a recording medium tape device, the tape housed in a cartridge, the tape having leader tape comprising marked segments of a plurality of distinctive markings such that each marking indicates a corresponding tape status; and
automatically moving the recording medium tape such that a marked segment of the leader tape having a marking indicative of the tape status is visible through the cartridge.

18. The machine-readable medium of claim 17 wherein the marked segment of leader tape aligns with a reference pointer located on the cartridge.

19. The machine-readable medium of claim 17 wherein moving is selected from the group consisting of winding and rewinding.

20. The machine-readable medium of claim 17 wherein the distinctive markings comprise colors.

21. The machine-readable medium of claim 18 wherein the recording medium tape device is a memory-in-cassette device.

22. The machine-readable medium of claim 18 wherein the colored segment of leader tape is visible through an inspection window.

23. The machine-readable medium of claim 20 wherein the colored segment of leader tape is formed by multiple segments of colored leader tape of the same color positioned to stack upon rewinding.

24. The machine-readable medium of claim 19 wherein the tape status is determined from a group of tape statuses consisting of new, initialized, end of life, error rate warning, error rate exceeded, and secure.

25. A tape cartridge comprising:
a tape cartridge housing;
tape located within the housing, the tape including leader tape comprising marked segments of a plurality of distinctive markings each marking indicates a corresponding tape status, wherein the tape can be moved to make visible at least one marking indicative of the cartridge status.

26. The tape cartridge of claim 25 wherein the marked segment of leader tape aligns with a reference pointer located on the cartridge.

27. The tape cartridge of claim 25 wherein moving is selected from the group consisting of winding and rewinding.

28. The tape cartridge of claim 25 wherein the distinctive markings comprise colors.

29. The tape cartridge of claim 28 wherein the recording medium tape device is a memory-in-cassette device.

30. The tape cartridge of claim 26 wherein the colored segment of leader tape is visible through an inspection window.

31. The tape cartridge of claim 28 wherein the colored segment of leader tape is formed by multiple segments of colored leader tape of the same color positioned to stack upon rewinding.

32. The tape cartridge of claim 27 wherein the tape status is determined from a group of tape statuses consisting of new, initialized, end of life, error rate warning, error rate exceeded, and secure.
